(19) United States
(12) Patent Application Publication
(10) Pub. No.: US 2006/0131549 A1
(43) Pub. Date: Jun. 22, 2006

(54) Fire retardant for wood products

(76) Inventors: David Glassel, Spring, TX (US); Gary Ernest Mellema, Grapevine, TX (US)

Correspondence Address: Martin L. McGregor, 26415 Oak Ridge Drive, Spring, TX, 77380, US

(21) Appl. No.: 11/016,225

(22) Filed: Dec. 17, 2004

(51) Int. Cl. C09K 21/00

(52) U.S. Cl. 252/607; 252/601

(57) ABSTRACT

The invention provides a method for increasing fire resistance in wood that comprises contacting with the wood to be treated with a copolymer base of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and maintaining the contact for a time sufficient to establish a change in the chemical structure of the wood which is reflected in an increase in at least one measurable parameter reflecting an increase in the strength of the wood over an untreated wood from the same lot. Preferably the method further comprises mixing a cross-linking agent with the copolymer that comprises a siloxane polymer of the general formula: (MₐD_{b}T_{c}Q_{d})ₓ meeting the following parameters apply: the ratio of a/(c+d) is between 0 and 4; the ratio of b to the rest is not subject to limitation provided the final cross-linking agent viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable group.

### TECHNICAL FIELD

This invention provides methods for increasing fire resistance properties of wood. The invention also provides fire resistant wooden articles of manufacture.

### BACKGROUND OF THE INVENTION

In the prior art numerous materials are known that retard the burning or spread of flame in wood.

Modification of wood to increase its fire resistance by treatment with siloxanes is disclosed in U.S. Pat. No. 5,652,026 and references cited therein. The methylsiloxanes disclosed require the presence of a boron or phosphorus function, while the references cited therein focused on formation of inorganic complexes with metal alkoxides within the wood cells. None of the references recognized that changing the surface activity of cellulose or lignocellulose structures with simple carbon substituted siloxanes would produce the beneficial results sought while avoiding the use of potentially toxic materials such as the metal salts, phosphorus and boron compounds.

Another use of siloxane reagents to modify wood or cellulose materials to increase fire resistance is found in U.S. Pat. Nos. 5,204,186 and 5,120,581. These patents teach a very broad group of silicon based compounds useful as fire retardants. The silioxane materials disclosed require either at least one group in each molecule that contains a halogen, or a group having a silicon bond that requires less than 72 kcal/mole to break. Neither of these requirements is present in the compounds of the present invention.

U.S. Pat. No. 6,303,234 involves a process of imparting fire retardant properties to a cellulosic material comprising coating a cellulosic material with sodium silicate by contacting a sodium silicate solution with the material to be coated. dehydrating the coating, and depositing a coating of a silicon oxide glassy film on the sodium silicate coated material. In one embodiment, the coating of silicon oxide is a monomolecular layer of silicon monoxide. The “water glass” or liquid sodium silicate is a salt of silicic acid, and while it may include polysilicates is quite different from the siloxane polymers of the present invention.

No art was found that teaches increasing tire resistance by contacting the wood with a siloxane polymer optionally diluted with a hydrocarbon solvent carrier, and optionally a naturally occurring oil. A method and composition to practice the novel treatment, and produce novel articles of manufacture are set out below.

### SUMMARY OF THE INVENTION

The invention provides a method for increasing fire resistance in wood that comprises contacting with the wood to be treated with a copolymer base of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and maintaining the contact for a time sufficient to establish a change in the chemical structure of the wood which is reflected in an increase in at least one measurable parameter reflecting an increase in the strength of the wood over an untreated wood from the same lot. Preferably the method further comprises mixing a cross-linking agent with the copolymer that comprises a siloxane polymer of the general formula: (MₐD_{b}T_{c}Q_{d})ₓ meeting the following parameters apply: the ratio of a/(c+d) is between 0 and 4; the ratio of b to the rest is not subject to limitation provided the final cross-linking agent viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable group and maintaining the contact for a time sufficient to establish a change in the wood which is reflected in a change in at least one measurable parameter reflecting a decrease in fire hazard of the wood over untreated wood from the same lot. It is also preferred to provide a crosslinking catalyst mixed with the copolymer. Any crosslinking catalyst known in the art may be used however preferred catalysts are tetraalkyl titanates or tetraalkyl zirconates where the alkyl groups may be the same or different. This mode of treatment provides a surface treatment and in some woods permeation of the wood is possible with some undiluted polymers, however it is generally preferred to dilute the polymer with a solvent. While an aqueous solvent or even high pressure steam might be used, hydrocarbon solvents are preferred.

Because the viscosity of the copolymer may decrease or prevent penetration to the interior of the wood, it is desirable to dilute the copolymer with a hydrocarbon solvent. Use of a hydrocarbon solvent also decreases the rate of undesirable side reactions such as gel formation. Although any hydrocarbon solvent that carries the copolymer into cellulose fiber structures, such as wood, may be used the preferred solvents are aliphatic solvents composed primarily of C₇-C₁₆ paraffinic, cycloparaffinic and isoparaffinic hydrocarbons containing less than about 0.5% aromatic hydrocarbons. More preferably, the aliphatic solvent is composed primarily of C₉-C₁₄, paraffinic, cycloparaffinic and isoparaffinic hydrocarbons and of those range of C₁₀-C₁₃ is preferred. The current most preferred solvent is Conosol 145 marketed by Penreco, Inc, of Houston, Tex. Optionally additional benefits maybe obtained by adding to the treatment mixture a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil. Preferred oils are cedar oil, cinnamon oil, citronella oil, clove oil, eucalyptus oil, juniper oil, tall oil, and pine oil. The most preferred oil is cedar oil.

In the copolymer the R groups may be the same or different and each is a lower alkyl group preferably of no more than four carbons. Especially preferred are those copolymers wherein all non-terminal copolymer R groups are methyl. In the preferred cross-linking agent each has an R group in an alkoxy group that is an alkyl group comprising from 1 to 4 carbon atoms. Especially preferred cross-linking agents further comprise methyl groups at each non-alkoxy position.

The invention also provides novel articles of manufacture comprising wood processed according to the various embodiments summarized above. Treatment according to the methods of the invention generates polymers within the structural matrix of the wood which increase the energy necessary to ignite the wood fibers and thus inhibit combustion.

### DETAILED DESCRIPTION OF THE INVENTION

General Description of the Invention

The conventional wisdom regarding fire retardant materials exemplified by a standard text, “Construction: Principles, Materials, and Methods” by Simmons, H. Leslie.; Olin, Harold Bennett, New York, N.Y., John Wiley & Sons, Inc. (US), 2001, Chapter 6 page 366 et seq., {Cited below as Simmons et al.} (Captions deleted from quotation. “. . . ” indicates deletions other than captions and [ ] indicates insertions or change in case), The natural fire resistance of wood can be greatly enhanced by its impregnation with inorganic salts that react chemically at temperatures below the ignition point of wood. This reaction causes the combustible vapors normally generated in the wood to break down into nonflammable water and carbon dioxide. Fire-retardant-treated wood has been marketed since World War II. Today's treatment methods and chemicals provide a uniformity that was earlier unattainable. Products tested and approved by the Underwriters' Laboratories, Inc. (UL) and which bear its label are recognized by model building code authorities and federal agencies as suitable for structural use in fire-resistive and noncombustible construction. After treatment, plywood and lumber, 2 in. (50 mm) nominal or less in thickness should be dried to a moisture content of 19% or less. Designers may want to require a lower moisture content for fire retardant-treated wood to be used for millwork, cabinets, office paneling, and other special uses. Fire-retardant-treated wood is generally not suitable for transparent finishes. Most of it is painted when exposed to view. Except where exterior-grade treatment complying with rain-testing requirements has been employed, fire-retardant-treated wood should not be used where it will be exposed directly to the weather. The presence of fire-retardant chemicals in treated wood may prohibit the use of some wood preservatives, such as chromated copper arsenate CCA.

In contrast to the conventional approach, the present invention does not use inorganic salts or other potentially hazardous materials to achieve fire retardant effects. Instead the wood is modified by treatment with stabilizing materials to increase the energy needed to break down the components of wood, especially adding chemical stability to the relatively fragile carbohydrate moieties of the cellulose structure. The silicone copolymers of the invention also reduce the amount of free water bound to the lignocellulose structures of the treated wood. This in turn reduces the formation of steam within the heated wood which tends to sweep volatile, flammable gases out of the vascular system of the wood and into the air where they have sufficient available oxygen to ignite.

### EXAMPLE 1

A copolymer solution suitable for treating wooden materials according the invention is prepared by slowly adding a mixture of 5 parts cedar oil and 10 parts of a silicone polymer obtained from GT Products, Inc. of Grapevine, Tex. designated X5814 to 80 parts of Conosol 145, with the parts ratio based on final composition by weight. When the addition is complete, 4 foot sections cut from building grade 8 foot pine 2×4s are immersed in a tank of circulating solution for one hour and dried to constant weight. The untreated 4 ft section of each 2×4 was market and used as a control in subsequent tests.

Randomly selected treated and the matching untreated 2×4s are split and the interior portions of the split wood was sprayed with water. The treated wood showed water beading even in the center of the material while all surfaces of the untreated portions were readily wet, showing complete penetration of the copolymer to the interior of the wood.

### EXAMPLE 2

Fire Retarding Effects

Wood is inherently inhomogeneous. In addition, it is highly anisotropic with properties that depend highly upon whether they are measured along the grain, across the grain or tangentially to the grain. Variations due to species and growing conditions (even within a species) add to the variability. Consequently, it is unrealistic to expect a limited number of samples to be totally representative regarding the burning characteristics of a given species.

ASTM 1234-34 was developed for testing the burning characteristics of treated fabric. The test reported below is from an adaptation of ASTM 1234-34 for wood appropriate for preliminary screening. The burn procedure outlined below attempts to reduce some of this variability inherent in burning wood. It does provide a controlled, draft free environment the single most important feature to achieving some degree of reproducibility. The limited data presented below is intended to demonstrate the improvement gained by treatment and not to reflect statistical evaluation of the samples for marketing or safety classifications.

The Test chamber is as specified for ASTM 1234-34 modified to take wood samples. The samples were 2 in. by 3 in. by 12 in. trimmed from kiln dried commercial nominal 2×4 lumber and cut to size with 0.25 in tolerance. Additional 2 in. by 3 in. by 2 in. samples were cut adjacent each 12 in. sample and tested for moisture content. Test pieces were suspended vertically in the test chamber from hooks inserted into 0.25 in. diameter holes drilled 0.75 in. from the outer edges at the top of each test piece. The fabric holding center support was modified to brace the wood sample. Samples were cut by ripping from the center of the larger pieces. The flame is supplied by a Bunsen burner modified to burn propane. The burner at full air flow was adjusted with no sample in place to produce a clear flame 1.5 inches high with a bright blue cone 0.75 inches high. The burner is supported under the test sample so that the tip of the bright cone touches the center bottom of the test piece. The samples are weighed to the nearest 0.01 grams if less than 200 grams and to the nearest 0.1 gram if heavier. The wood specimen was positioned in the flame, the cabinet was closed and burn allowed to proceed for 60 sec. in the burner flame extinguished. After the burner flame is removed, the time with a visible flame was noted and recorded. The time that a glow was visible after the visible flame was also noted. The sample is allowed to cool and the length of the char is noted. The final weight for each sample is also determined and recorded. The samples were treated as described in example I above. The results are shown in Table I below. In each case less damage was noted in the treated sample. Times are in seconds, weights in grams. The samples 1,4 and 7 were from the same board, 2,5 and 8 were from a second board and 3, 6 and 9 from a third board. The samples were treated as in example 1 above with a mixture of 85% Conosol 145 solvent, 10% X5814 and 5% cedar oil.

| | | Initial | Burnt | % | Burn | Afterflame | Afterglow |
|---|---|---|---|---|---|---|---|
| Sample | Treatment | Weight | Weight | Weight Loss | Time in Sec | Time in Sec | Time in Sec |
| 1 | None | 125.11 | 116.59 | 9.95% | 60 | 429 | 53 |
| 2 | None | 197.08 | 190.20 | 9.42% | 120 | 240 | 8 |
| 3 | None | 190.16 | 183.95 | 9.32% | 90 | 246 | 43 |
| 4 | 85.10.5 | 125.22 | 115.13 | 9.42% | 60 | 236 | 51 |
| 5 | 85.10.5 | 202.30 | 198.52 | 9.25% | 60 | 199 | 43 |
| 6 | 85.10.5 | 197.91 | 190.30 | 9.80% | 60 | 282 | 136 |
| 7 | Solvent C145 | 126.01 | 112.56 | 9.92% | 60 | 379 | 43 |
| 8 | Solvent C145 | 204.40 | 196.19 | 9.48% | 60 | 493 | 79 |
| 9 | Solvent C145 | 188.12 | 180.80 | 9.26% | 60 | 417 | 95 |

We Claim:

1. A method for increasing fire resistance in wood that comprises contacting with the wood to be treated with a copolymer base of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and maintaining the contact for a time sufficient to establish a change in the wood which is reflected in a change in at least one measurable parameter reflecting a decrease in fire hazard of the wood over untreated wood from the same lot.

2. The method of claim 1 that further comprises mixing a cross-linking agent with the copolymer that comprises a siloxane polymer of the general formula: (MₐD_{b}T_{c}Q_{d})x formula to which the following parameters apply: the ratio of a/(c+d) is between 0 and 4; the ratio of b to the rest is not subject to limitation provided the final cross-linking agent viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable group.

3. The method of claim 1 that further comprises providing a crosslinking catalyst mixed with the copolymer.

4. The method of claim 3 wherein the catalyst is a tetraalkyl titanate or tetraalkyl zirconate.

5. The method of claim 1 comprising diluting the copolymer with an aliphatic solvent composed primarily of C₇-C₁₆ paraffinic, cycloparaffinic and isoparaffinic hydrocarbons containing less than about 0.5% aromatic hydrocarbons.

6. The method of claim 5 comprising wherein the aliphatic solvent is composed primarily of C₉-C₁₄, paraffinic, cycloparaffinic and isoparaffinic hydrocarbons.

7. The method of claim 5 comprising wherein the aliphatic solvent is composed primarily of C₁₀-C₁₃, cycloparaffinic and isoparaffinic hydrocarbons.

8. The method of claim 5 comprising the aliphatic solvent Conosol 145.

9. The method of claim 5 further comprising a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil.

10. The method of claim 9 wherein the oil is from the group consisting of cedar oil, cinnamon oil, citronella oil, clove oil, eucalyptus oil, juniper oil, tall oil, and pine oil.

11. The method of claim 1 wherein the oil is cedar oil.

12. The method of claim 1 wherein R groups may be the same or different and each is a lower alkyl group of no more that four carbons.

13. The method of claim 1 that wherein all non-terminal copolymer R groups are methyl.

14. The method of claim 2 that comprises a crosslinker having wherein an R group in an alkoxy group is an alkyl group comprising from 1 to 4 carbon atoms.

15. The method of claim 14 that further comprises methyl groups at each non-alkoxy position.

16. An article of manufacture comprising wood processed according to claim 1.

17. An article of manufacture comprising wood processed according to claim 5.

18. An article of manufacture comprising wood processed according to claim 8.

19. An article of manufacture comprising wood processed according to claim 9.

20. An article of manufacture comprising wood processed according to claim 11.
